(19) United States
(12) Patent Application Publication
(10) Pub. No.: US 2007/0251751 A1
(43) Pub. Date: Nov. 1, 2007

(54) Cast Aluminum Frame Component for Golf Cars and Small Utility Vehicles

(75) Inventors: Landon Ball, North Augusta, SC (US); Warren Clark, Evans, GA (US); Michael J. Hebert, Evans, GA (US)

Correspondence Address: HARNESS, DICKEY & PIERCE, P.L.C., P.O. BOX 828, BLOOMFIELD HILLS, MI, 48303, US

(73) Assignee: Textron Inc., Providence, RI (US)

(21) Appl. No.: 11/380,967

(22) Filed: May 1, 2006

(51) Int. Cl. B62D 21/00

(52) U.S. Cl. 180/312; 280/781

(57) ABSTRACT

A small utility vehicle frame can include a unitary cast component. The unitary cast component can be a single, integral element or part having a variety of structural portions and/or attachment features formed therein. The attachment features can provide for the direct attachment of auxiliary frame components and other vehicle components to the unitary cast component. The unitary cast component can be machined to accommodate tolerances required for the attachment of other components. The unitary cast component can extend about two-thirds of the length of the vehicle frame.

### FIELD

The present disclosure relates to a frame component for a small utility vehicle and a method of manufacturing a small utility vehicle, such as a golf car.

### BACKGROUND

The statements in this section merely provide background information related to the present disclosure and may not constitute prior art.

Small utility vehicles can include: golf cars, shuttle personnel carriers, refreshment vehicles, industrial utility vehicles and/or trail utility vehicles. Small utility vehicles come in many different configurations that vary both in size and components or features that are present thereon.

Small utility vehicles typically include a frame. The frame can be made of steel and can require assembly. The frame can include several frame members that can be welded or otherwise attached together. Additionally, brackets or other attachment features can be welded or otherwise attached to frame members to provide a foundation for the fastening of components of the small utility vehicle thereto. The attachment of these features can increase the manufacturing cost of the small utility vehicle. Furthermore, a steel frame can have a relatively high weight and relatively high susceptibility to corrosion. The heavier frame can decrease the performance or efficiency of the small utility vehicle. The corrosion can reduce the useful life of the small utility vehicle.

Accordingly, it would be desirable to provide a unitary small utility vehicle frame or component thereof including frame members and/or attachment features formed therein. Additionally, it would be desirable to provide a relatively light weight frame with a relatively high resistance to corrosion.

### SUMMARY

The present disclosure provides a small utility vehicle frame. The small utility vehicle frame can include a unitary cast component. The unitary cast component can have a pair of longitudinally extending and transversely spaced apart main portions and at least one cross portion extending transversely between the main portions.

The present disclosure further provides a small utility vehicle. The vehicle can include a frame having a unitary cast component. The unitary cast component can include a pair of main portions extending longitudinally along the vehicle and at least one cross portion extending transversely between the main portions. The vehicle can further include at least one vehicle component directly attached to the unitary cast component. Additionally, the vehicle can include a plurality of wheels rotatably coupled to the frame. The wheels can include at least one driven wheel. Furthermore, the vehicle can include a power unit supported by the frame and operably coupled to at least one driven wheel.

The present disclosure further provides a method of manufacturing a small utility vehicle. The method can include providing a frame having a unitary cast component, the unitary cast component forming a majority of the frame. The method can further include attaching a plurality of vehicle components to the unitary cast component.

Further areas of applicability will become apparent from the description provided herein. It should be understood that the description and specific examples are intended for purposes of illustration only and are not intended to limit the scope of the present disclosure.

### DRAWINGS

The drawings described herein are for illustration purposes only and are not intended to limit the scope of the present disclosure in any way.

FIG. 1 is a perspective view of a small utility vehicle, in this case in the form of a golf car, according to the present disclosure;

FIG. 2 is a perspective view of a unitary cast component of a frame for a small utility vehicle according to the present disclosure;

FIG. 3 is a cross-sectional view along line 3-3 of FIG. 2;

FIG. 4 is a perspective view of the underside of the unitary cast component of FIG. 2;

FIG. 5 is a perspective view of an assembly including the unitary cast component of FIG. 2 attached to auxiliary components of the frame and having various vehicle components disposed thereon;

FIG. 6 is a perspective view of the underside of the assembly of FIG. 5.

FIG. 7 is a perspective view of another assembly including the unitary cast component of FIG. 2 attached to auxiliary components of the frame and having various vehicle components disposed thereon;

FIG. 8 is a fragmented perspective view of a portion of the assembly of FIG. 7;

FIG. 9 is a fragmented perspective view of a front portion of the unitary cast component of FIG. 2 having various vehicle components attached thereto;

FIG. 10 is a side view of another small utility vehicle, in this case in the form of a vehicle having a storage bed, according to the present disclosure; and

FIG. 11 is a fragmented perspective view of a front portion of another frame according to the present disclosure having a unitary cast component attached to an auxiliary front component, the auxiliary front component having various vehicle components attached thereto.

### DETAILED DESCRIPTION

The following description is merely exemplary in nature and is in no way intended to limit the present disclosure, application, or uses. Throughout this specification, like reference numerals will be used to refer to like elements. For example, like elements may be referred to by the reference indicia 15, 15′, and 15″. Additionally, as used herein, the term “longitudinal” refers to a direction along or substantially parallel to a fore and aft centerline of a small utility vehicle. Furthermore, as used herein, the term “transverse” refers to a direction substantially perpendicular to the longitudinal direction and extends across the small utility vehicle.

According to the present disclosure, a small utility vehicle frame can include a unitary cast component. The unitary cast component can be a single, integral element or part having a variety of structural portions and/or attachment features formed therein. The attachment features can provide for the direct attachment of auxiliary frame components and other vehicle components to the unitary cast component. The unitary cast component can be machined to accommodate tolerances required for the attachment of other components. The unitary cast component can extend about two-thirds of the length of the vehicle frame. The unitary cast component can be aluminum and resist corrosion.

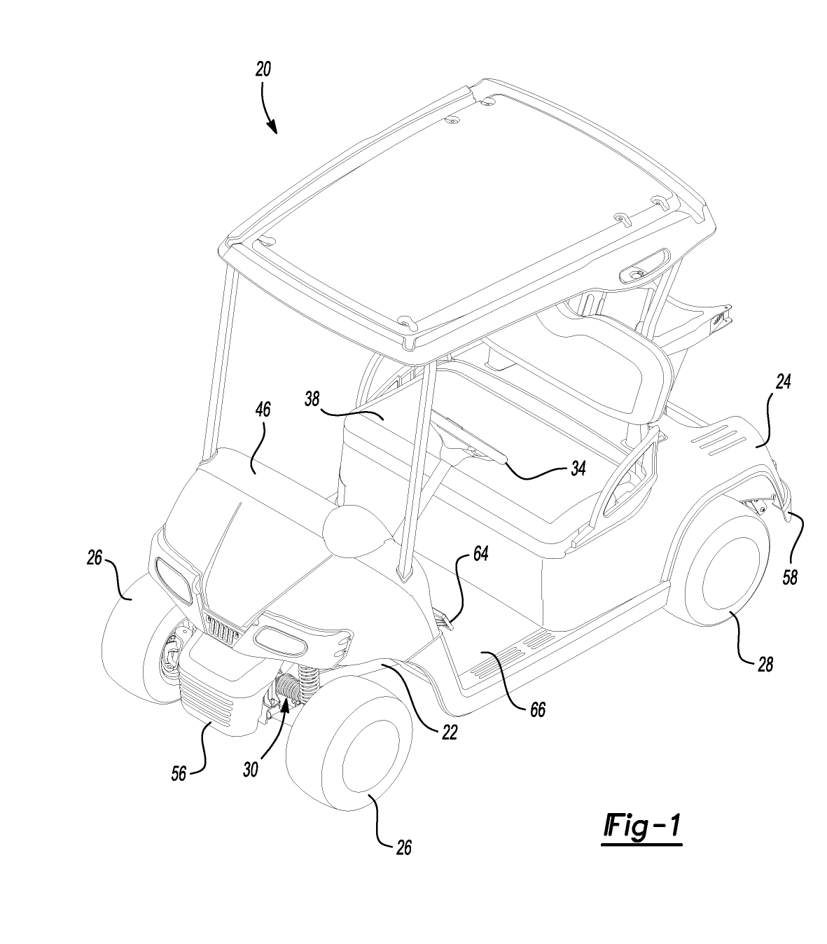

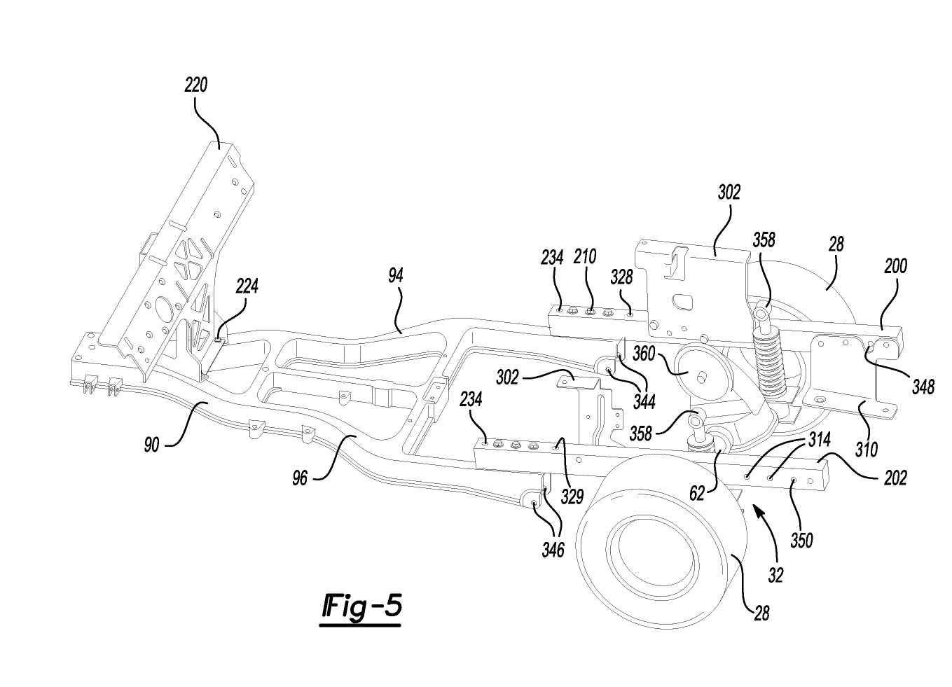

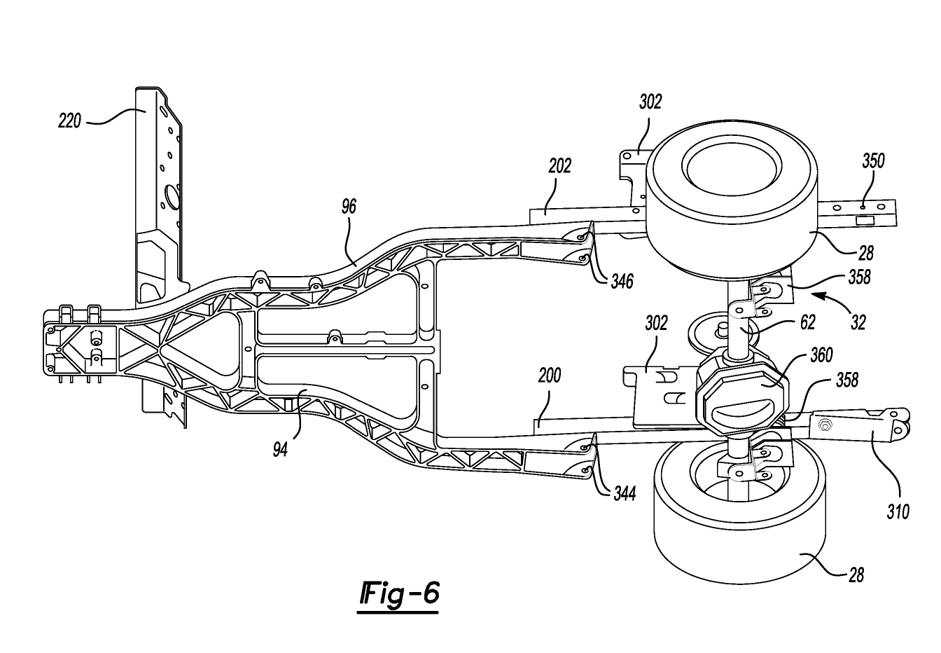

Referring to FIG. 1, an exemplary small utility vehicle 20, in this case in the form of a golf car, according to the present disclosure is shown. As used herein, the term “small utility vehicle” includes, but is not limited to, golf cars, shuttle personnel carriers, refreshment vehicles, industrial utility vehicles and/or trail utility vehicles. Vehicle 20 includes various components that are mounted to a frame 22. The particular components may vary based upon the configuration or type of small utility vehicle to be formed. According to the present disclosure, frame 22 can include a unitary cast component or body, as described below. Vehicle 20 can further include body panels 24 supported from frame 22. Frame 22 can also support a plurality of wheels including steerable wheels 26 in addition to powered or driven wheels 28. A front suspension system 30 can be used to support steerable wheels 26. Driven wheels 28 can be connected to frame 22 with a rear suspension system 32 (FIGS. 5-6). A steering mechanism 34, which commonly includes a steering wheel and a support post assembly, can also be included to provide the steering input to steerable wheels 26.

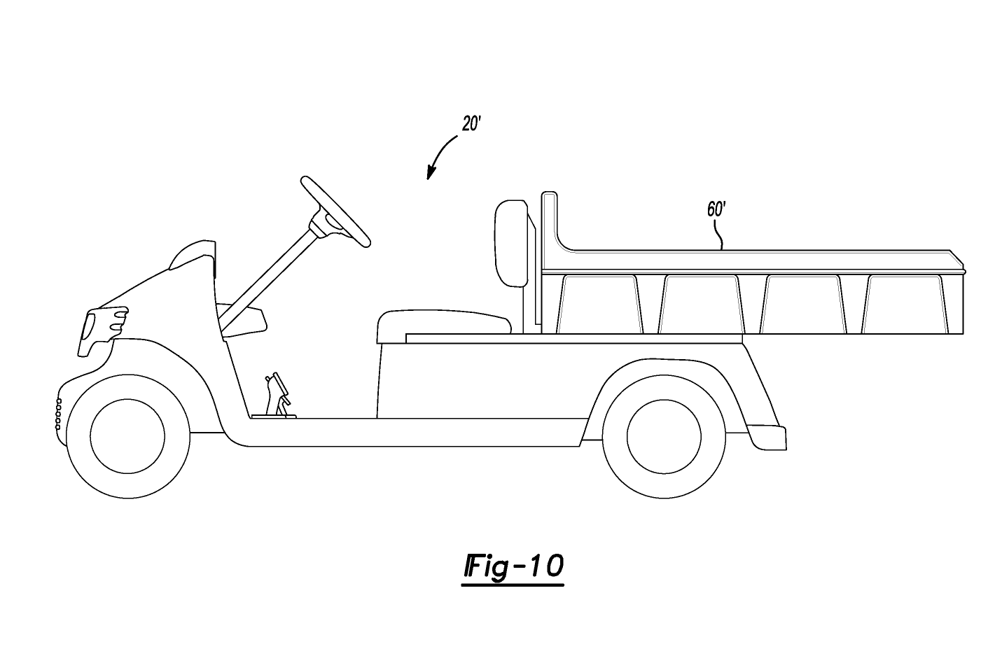

Vehicle 20 can include a front seating area 38. An instrument panel 46 can be included in a front portion of vehicle 20 and may house various components, such as instruments controlling the operation of vehicle 20 and/or indicating the operational status of vehicle 20 along with storage compartments and the like by way of non-limiting example. Front and rear bumpers 56, 58 can be attached to frame 22. Other items that can be provided when vehicle 20 is in the form of a golf car include golf bag support equipment, accessory racks or bins, headlights, side rails, fenders or the like. Moreover, when vehicle 20 is configured as other types of vehicles, a rear-facing seat or multiple rows of seats may be included, a storage bed (tiltable or fixed) may be attached to the rear portion of vehicle 20, and beverage compartments may be attached to the rear portion of vehicle 20 and the like, by way of non-limiting example. For example, small utility vehicle 20′ can include a storage bed 60′ as shown in FIG. 10.

Vehicle 20 is commonly propelled by a power unit (not shown), which is commonly disposed behind or below front seating area 38. The power unit can be an internal combustion engine assembly or a battery and electric motor assembly. The power unit drives driven wheels 28 and is typically attached to a drive axle 62 (FIGS. 5-6) interconnecting driven wheels 28 and frame 22. The power unit enables driven wheels 28 to propel vehicle 20 in both a forward and rearward direction with steering provided by steerable wheels 26 via input from steering mechanism 34.

Vehicle 20 can include a pedal assembly 64 that can control the output level of the power unit and the braking function of vehicle 20. Pedal assembly 64 can be attached to frame 22 and can extend through a floorboard 66. Floorboard 66 can also be attached to frame 22 and can define an interior surface of vehicle 20.

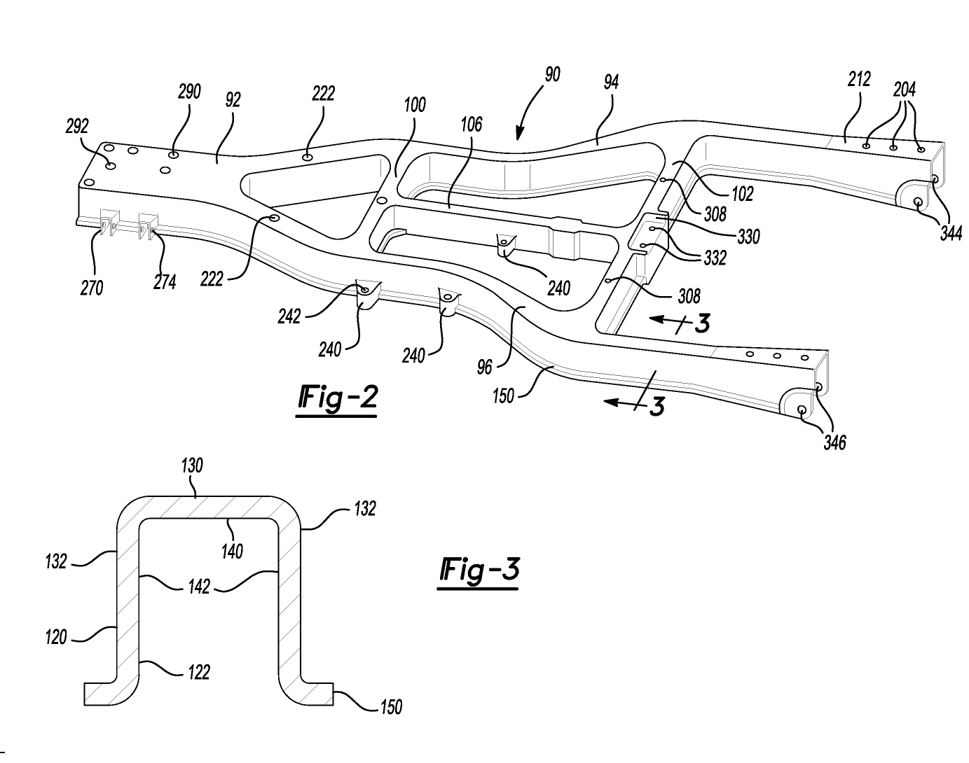

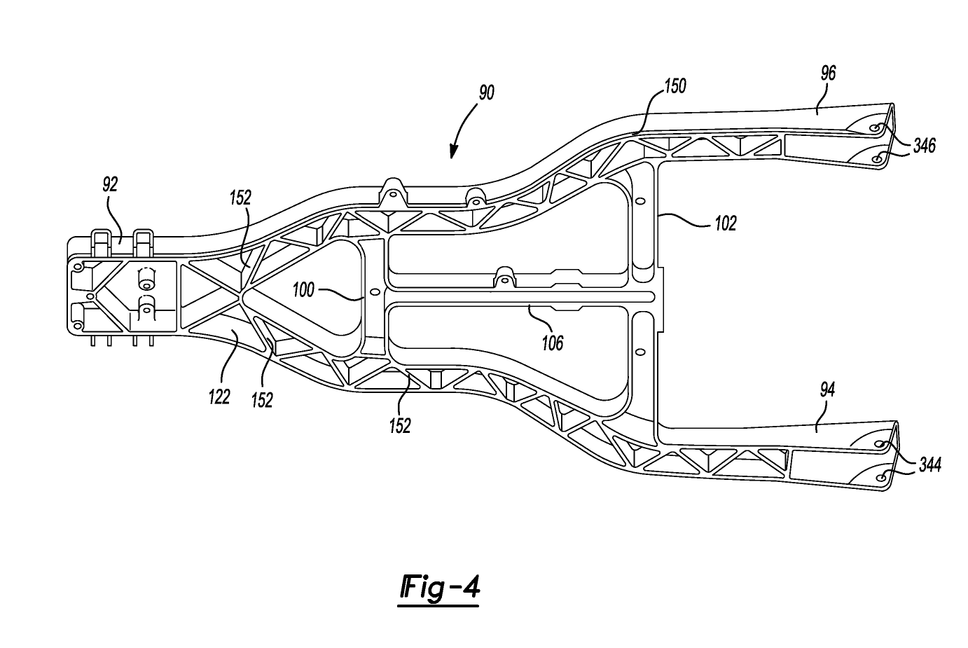

Referring to FIGS. 2-4, frame 22 can be a multi-piece frame and can include a unitary cast component or body 90 to which additional frame members are attached, as described below. Unitary cast body 90 can form a majority of frame 22 and can extend about two-thirds of the length of frame 22, as described below. Unitary cast body 90 can be a single, integral element or part having a variety of structural portions and/or attachment features formed therein. Specifically, unitary cast body 90 can include a base portion 92 and longitudinally extending first and second main portions 94, 96. Main portions 94, 96 can extend rearwardly from base portion 92 and can be transversely spaced apart. Main portions 94, 96 can be contoured as shown in FIGS. 2 and 4. Unitary cast body 90 can further include first and second cross portions 100, 102. Cross portions 100, 102 can be longitudinally spaced apart and can extend transversely between main portions 94, 96. Additionally, unitary cast body 90 can include a support portion 106, which can extend longitudinally between cross portions 100,102. Cross portions 100,102 and support portion 106 can provide stability to unitary cast body 90 and, along with the other members of unitary cast body 90, can provide a foundation for the attachment of various components of vehicle 20, as described in further detail below.

As shown in FIG. 3, the portions of unitary cast body 90 can have an inverted U-shaped cross section. Unitary cast body 90 can define an outside surface 120 and an inside surface 122. Outside surface 120 can have a top section 130 and side sections 132. Inside surface 122 can have a top section 140 and side sections 142. Unitary cast body 90 can also include a lip 150 that can extend outwardly from side sections 132 opposite top section 130. As shown in FIG. 4, unitary cast body 90 can include ribs 152 that provide additional strength and stability to unitary cast body 90. Ribs 152 can extend between sections of inside surface 122.

Unitary cast body 90 can include a plurality of attachment features to facilitate the coupling of various components of vehicle 20 thereto. The attachment features can be in the form of apertures through unitary cast body 90, protrusions extending outwardly from unitary cast body 90, recesses in unitary cast body 90, and/or combinations thereof, by way of non-limiting example. The attachment features can be positioned to correspond with complementary features on components of vehicle 20 to be attached to unitary cast body 90. Exemplary attachment features and the components related thereto are described in detail below.

Unitary cast body 90 can be made of aluminum and can be formed by a variety of high strength casting processes. Suitable types of aluminum can include 6061 aluminum and A356 aluminum and may have a T6 heat treatment, by way of non-limiting example. Suitable processes can include pressure counter pressure casting; vacuum riserless casting/pressure riserless casting; and tilt pour casting, by way of non-limiting example. Such casting processes are known and, therefore, are not discussed in further detail herein. Advantageously, during the formation of unitary cast body 90 through such casting processes, the structural portions and attachment features, such as apertures and protrusions, can be contemporaneously formed therein.

According to the present disclosure, unitary cast body 90 can be machined to accommodate tolerances required for the assembly of vehicle 20. For example, as described in further detail below, parts of top section 130 can be machined to accommodate the attachment of auxiliary components of frame 22. In another example, apertures formed during casting can be machined to a specific size or machined to include such features as threads. Additionally, features such as apertures can be formed in unitary cast body 90 after the casting of unitary cast body 90 by machining.

Referring to FIGS. 5-8, frame 22 can further include first and second longitudinally extending auxiliary components or rails 200, 202. Auxiliary rails 200, 202 can be attached to main portions 94, 96 of unitary cast body 90 and extend rearwardly therefrom. Unitary cast body 90 and auxiliary rails 200, 202 can form frame 22. Unitary cast body 90 can extend longitudinally approximately two-thirds of frame 22.

Auxiliary rails 200, 202 can be made from relatively rigid materials such as boxed aluminum tubing. As the attachment of both auxiliary rails 200, 202 to unitary cast body 90 is similar, only the attachment of first auxiliary rail 200 is hereinafter described, but the description should also be understood to apply to second auxiliary rail 202.

First main portion 94 of unitary cast body 90 can include threaded apertures 204 (FIG. 2), and first auxiliary rail 200 can have complementary apertures (not shown). First auxiliary rail 200 can be attached to first main portion 94 of unitary cast body 90 with complementary threaded fasteners 210 that extend through first auxiliary rail 200 and engage with threaded apertures 204. First main portion 94 can further include an engagement surface 212 (FIG. 2) that engages with first auxiliary rail 200. Engagement surface 212 can be machined to provide a desired interface between unitary cast body 90 and first auxiliary rail 200.

Referring to FIGS. 5-7 and 9, vehicle 20 can further include an instrument panel support assembly 220 attached to unitary cast body 90. Instrument panel support assembly 220 can provide a foundation for the attachment of instrument panel 46 (FIG. 1) and floorboard 66. Instrument panel support assembly 220 can take a variety of configurations as shown in FIGS. 5-7 and 9. Portions of unitary cast body 90 can include threaded apertures 222 (FIG. 2) that can be used to attach instrument panel support assembly 220 thereto. Instrument panel support assembly 220 can include complementary apertures (not shown) that align with threaded apertures 222. Threaded fasteners 224 (FIG. 5) can extend through the apertures in instrument panel support assembly 220 and engage with threaded apertures 222 to secure instrument panel support assembly 220 to unitary cast body 90. Instrument panel support assembly 220 can be made of a relatively rigid material, such as steel.

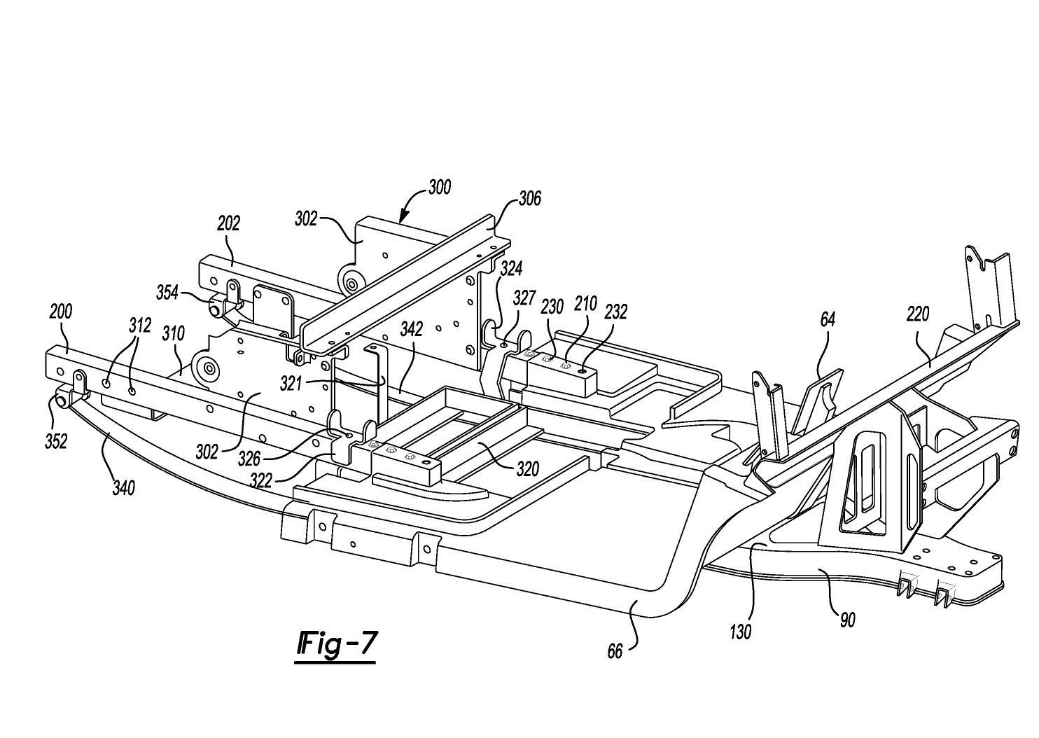

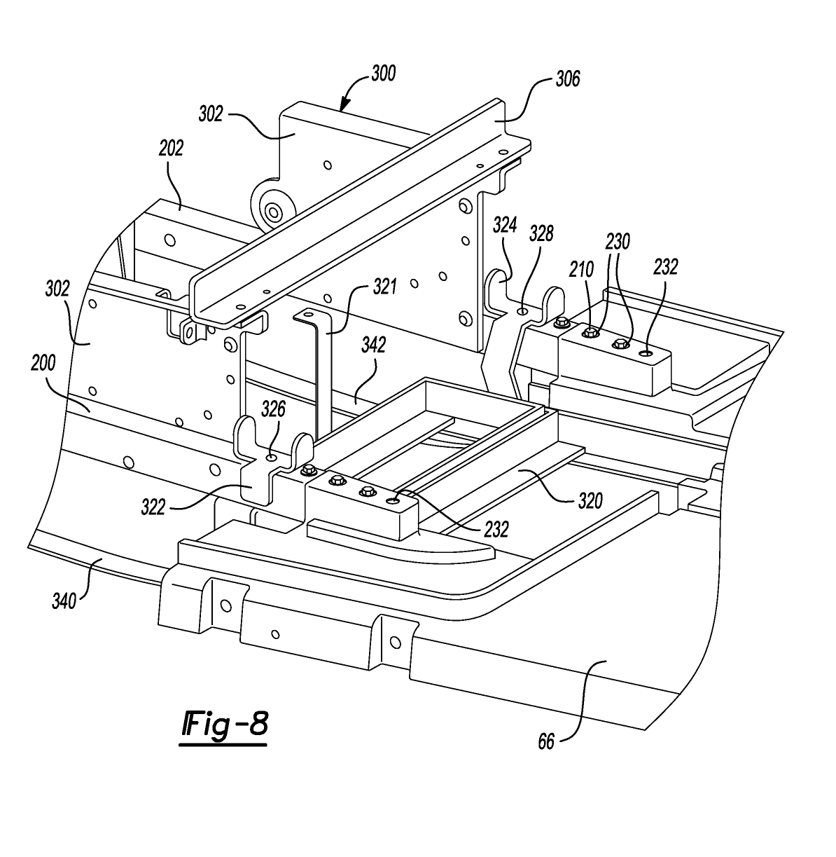

Vehicle 20 can further include floorboard 66. As shown in FIGS. 7-8, portions of floorboard 66 can rest on top section 130 of unitary cast body 90. Floorboard 66 can be attached to auxiliary rails 200, 202 and to instrument panel support assembly 220. For example, floorboard 66 can have apertures 230 that fit around the heads of threaded fasteners 210 and can have apertures 232 that align with apertures 234 of auxiliary rails 200, 202 (FIG. 5). Fasteners (not shown) can extend through apertures 232 and engage with apertures 234 to secure floorboard 66 to auxiliary rails 200, 202. Floorboard 66 can be made of a polymeric material, such as glass-filled polypropylene.

Vehicle 20 can also include pedal assembly 64 (FIGS. 1 and 7) which can be attached to unitary cast body 90. Unitary cast body 90 can include protrusions 240 (FIG. 2) on second main portion 96 and support portion 106 to facilitate attachment of pedal assembly 64 thereto. Protrusions 240 can have threaded apertures 242 therein. Pedal assembly 64 can have apertures (not shown) that align with threaded apertures 242 on protrusions 240. Threaded fasteners (not shown) can extend through the apertures in pedal assembly 64 and engage with threaded apertures 242 to attach pedal assembly 64 to unitary cast body 90. Pedal assembly 64 can include a variety of components and materials.

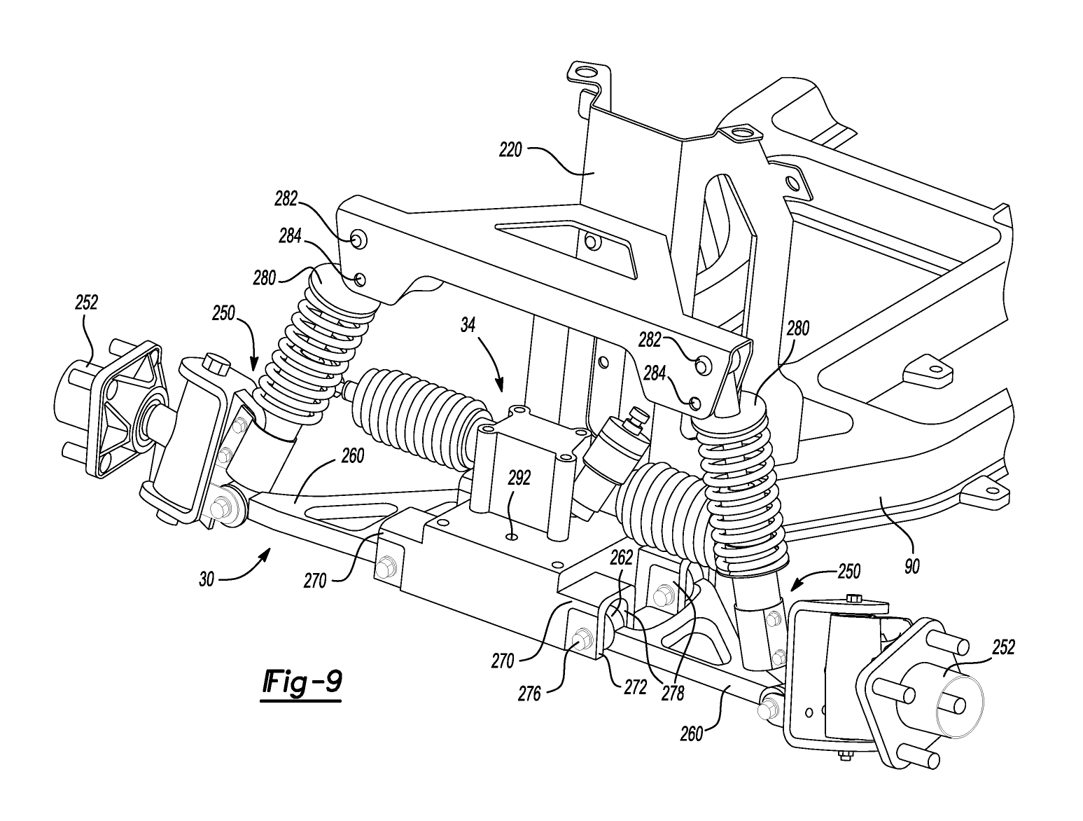

Vehicle 20 can further include front suspension system 30 and steering mechanism 34, shown in detail in FIG. 9. Both front suspension system 30 and steering mechanism 34 can include a variety of components and materials.

Front suspension system 30 can include knuckle assemblies 250 and can be attached to unitary cast body 90 and instrument panel support assembly 220. Each knuckle assembly 250 can couple front suspension system 30 and steering mechanism 34 to a hub 252 for each steerable wheel 26. An A-arm 260 of front suspension system 30 having cylindrical ends 262 can be coupled between each knuckle assembly 250 and unitary cast body 90. Unitary cast body 90 can include protrusions 270 extending transversely from base portion 92. Protrusions 270 can define an arch-shape with sidewalls 272 and can include apertures 274 (FIG. 2) through sidewalls 272. Protrusions 270 can receive cylindrical ends 262 between sidewalls 272. Cylindrical ends 262 can have through apertures (not shown) extending in the longitudinal direction corresponding to apertures 274. Front suspension system 30 can also include pins 276, which can extend into the corresponding apertures to attach each A-arm 260 to unitary cast body 90. Furthermore, sidewalls 272 can include machined surfaces 278. Machined surfaces 278 can provide a desired interface between cylindrical ends 262 and sidewalls 272, as well as pins 276 and sidewalls 272.

Additionally, front suspension system 30 can include struts 280 coupled between instrument panel support assembly 220 and knuckle assemblies 250. Instrument panel support assembly 220 can include apertures 282, 284 for securing struts 280 thereto. Apertures 282, 284 can provide for varying configurations of front suspension system 30.

Steering mechanism 34 can also be attached to unitary cast body 90. Unitary cast body 90 can include one or more apertures 290 (FIG. 2) in base portion 92, and steering mechanism 34 can be attached thereto by fasteners (not shown). Unitary cast body 90 can also include an aperture 292 (FIG. 2) through base portion 92 for the attachment of front bumper 56 (FIG. 1).

Various additional components of vehicle 20 can be attached to frame 22. A seat support assembly 300, shown in FIGS. 7-8, can be coupled between auxiliary rails 200, 202. Seat support assembly 300 can include side supports 302 attached to auxiliary rails 200, 202. Auxiliary rails 200, 202 and side supports 302 can have complementary apertures therethrough and be attached with fasteners (not shown). According to the present disclosure, side supports 302 can have a variety of other configurations, such as those shown in FIGS. 5-6. Furthermore, seat support assembly 300 can include a cross support 306 attached between side supports 302. Additionally, unitary cast body 90 can include apertures 308 (FIG. 2) for the attachment of other components (not shown) of seat support assembly 300. The various components of seat support assembly 300 can be made of a relatively rigid material, such as steel.

A rear bumper support 310 can also be attached to frame 22. As shown in FIG. 7, rear bumper support 310 can extend between auxiliary rails 200, 202 and provide a foundation for rear bumper 58 (FIG. 1). First auxiliary rail 200 can have apertures 312 (FIG. 7), and second auxiliary rail 202 can have apertures 314 (FIG. 5), all of which can be used to secure rear bumper support 310 to frame 22. According to the present disclosure, rear bumper support 310 can be made of a variety of materials and can have a variety of other configurations, such as shown in FIGS. 5-6.

Vehicle 20 can also include a battery tray 320 attached to frame 22. Battery tray 320, shown in FIGS. 7-8, can be included to support a plurality of batteries (not shown) when the power unit is in the form of a battery and electric motor assembly. Battery tray 320 can be made of aluminum with a plurality of members welded together. Battery tray 320 can include a support 321 for securing batteries into battery tray 320. Battery tray 320 can also include first and second brackets 322, 324 welded to rear portions thereof to support battery tray 320 from auxiliary rails 200, 202. Brackets 322, 324 can have apertures 326, 327 therethrough, respectively. Auxiliary rails 200, 202 can have threaded apertures 328, 329 (FIG. 5) complementary to apertures 326, 327. Brackets 322, 324 can be secured to auxiliary rails 200, 202 with threaded fasteners (not shown). Furthermore, battery tray 320 can include a front feature (not shown) that can correspond to a recess 330 and apertures 332 in cross portion 102 of unitary cast body 90 (FIG. 2). Fasteners (not shown) can also attach battery tray 320 at the front feature to unitary cast body 90 at recess 330.

Components of rear suspension system 32 of vehicle 20 can be attached to frame 22. Rear suspension system 32 can include first and second leaf springs 340, 342 (FIGS. 7-8) attached to auxiliary rails 200, 202 and unitary cast body 90. For example, unitary cast body 90 can include apertures 344, 346 proximate the rear ends of main portions 94, 96 (FIGS. 2 and 4-6), and leaf springs 340, 342 can be positioned as shown in FIG. 7 and attached thereto by fasteners (not shown). Additionally, auxiliary rails 200, 202 can include apertures 348, 350 (FIGS. 5-6), and leaf springs 340, 342, as shown in FIG. 7, can include brackets 352, 354 attached to auxiliary rails 200, 202 at apertures 348, 350 by fasteners (not shown). Rear suspension system 32 can also include struts 358 attached to drive axle 62 as shown in FIGS. 5-6. Additionally, a transmission assembly 360 (FIGS. 5-6) can be coupled to drive axle 62. Transmission assembly 360 can be operably coupled to the power unit to transmit power to driven wheels 28.

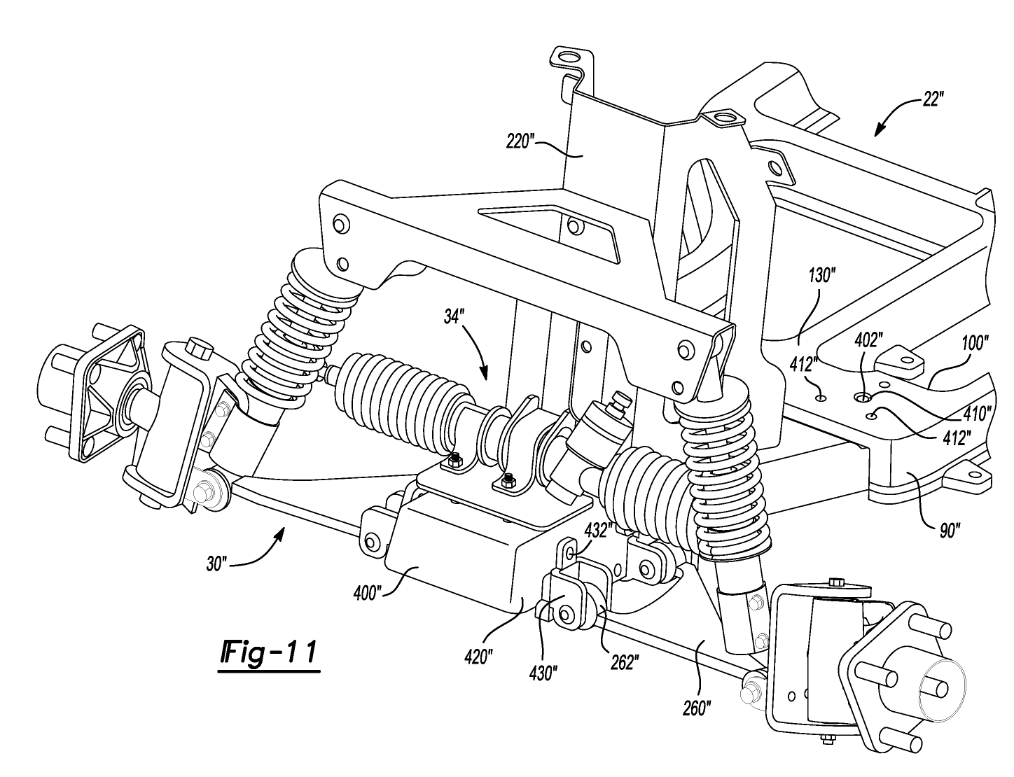

Referring now to FIG. 11, a front portion of another frame 22″ according to the present disclosure includes unitary cast body 90″ with a cast front component 400″ attached thereto. Cast front component 400″ can extend under top section 130″ of cross portion 100″ of unitary cast body 90″ and can include one or more alignment features 402″. Unitary cast body 90″ can include one or more apertures 410″ with which alignment features 402″ can engage to align cast front component 400″ relative to unitary cast body 90″. Unitary cast body 90″ can also include apertures 412″, and cast front component 400″ can include complementary apertures (not shown). Fasteners (not shown) can extend into aperture 412″ and engage cast front component 400″ to attach unitary cast body 90″ thereto. Cast front component 400″ can be the same as or similar to unitary cast body 90″, and can be aluminum.

Cast front component 400″ can also include a plurality of apertures (not shown) to which instrument panel support assembly 220″, front suspension system 30″, and steering mechanism 34″ can be secured. For example, one or more apertures (not shown) can extend through a side section 420″ of cast front component 400″. Front suspension system 30″ can include brackets 430″ attached to A-arm 260″ at cylindrical ends 262″. Brackets 430″ can have one or more apertures 432″ complementary to the apertures through side section 420″ of cast front component 400″. Fasteners (not shown) can secure brackets 430″ to cast front component 400″.

It is to be understood that the present disclosure can vary from the examples shown. The present disclosure can apply to a variety of small utility vehicles. Such small utility vehicles can have a variety of configurations and components. The frame and components described herein can have a variety of configurations, can be made of a variety of materials, and can be formed in a variety of processes. The vehicle components described herein can have a variety of configurations and be made from a variety of materials. Furthermore, the vehicle components can be attached to the vehicles in a variety of ways, such as with nuts and bolts and by welding, by way of non-limiting examples. Thus, the description herein is merely exemplary in nature and variations that do not depart from the gist of that which is described are intended to be within the scope of the disclosure. Such variations are not to be regarded as a departure from the spirit and scope of the disclosure.

What is claimed is:

1. A small utility vehicle frame comprising a unitary cast component, the unitary cast component including:
a pair of longitudinally extending main portions that are transversely spaced apart; and
at least one cross portion extending transversely between the main portions.

2. The frame of claim 1, wherein the portions of the unitary cast component have a U-shaped cross section and define an outer surface and an inner surface of the unitary cast component.

3. The frame of claim 2, wherein the unitary cast component further includes a plurality of ribs extending between sections of the inner surface.

4. The frame of claim 3, wherein the unitary cast component further includes a recess feature defined in a top section of the outer surface.

5. The frame of claim 4, wherein the unitary cast component further includes a lip extending outwardly from the outer surface opposite a top section of the outer surface.

6. The frame of claim 1, wherein the unitary cast component further includes at least one aperture therethrough.

7. The frame of claim 6, wherein the at least one aperture is threaded.

8. The frame of claim 1, wherein the unitary cast component further includes at least one protrusion extending outwardly therefrom, the protrusion including an aperture therethrough.

9. The frame of claim 8, wherein the at least one protrusion includes at least one machined surface.

10. The frame of claim 1, wherein the unitary cast component includes two longitudinally spaced apart cross portions extending transversely between the main portions and a support portion extending longitudinally between the two cross portions.

11. The frame of claim 10, wherein ends of the main portions approach one another and the unitary cast component further includes a base portion extending transversely between the approaching ends of the main portions and is longitudinally spaced apart from the cross portions.

12. The frame of claim 1, further comprising a pair of auxiliary frame rails attached to ends of the main portions and extending longitudinally therefrom.

13. The frame of claim 12, further comprising threaded fasteners attaching the auxiliary frame rails to the main portions, the main portions including machined outer surfaces and threaded apertures proximate the ends, the auxiliary frame rails engaging the machined outer surfaces and including complementary apertures therethrough, the threaded fasteners extending into the apertures of the auxiliary frame rails and engaging with the threaded apertures of the main portions.

14. The frame of claim 1, further comprising a cast front component attached to the unitary cast component, the cast front component extending transversely between ends of the main portions and longitudinally away from the at least one cross portion and the cast front component operable to support a front suspension system.

15. The frame of claim 1, wherein the unitary cast component is aluminum.

16. A small utility vehicle comprising:
a frame including a unitary cast component, the unitary cast component having a pair of main portions extending longitudinally along the vehicle and at least one cross portion extending transversely between the main portions;
at least one vehicle component directly attached to the unitary cast component;
a plurality of wheels rotatably coupled to the frame and including at least one driven wheel; and
a power unit supported by the frame and operably coupled to the at least one driven wheel.

17. The small utility vehicle of claim 16, wherein at least one of an instrument panel support assembly, a steering mechanism, a pedal assembly, and a suspension system is directly attached to the unitary cast component.

18. The small utility vehicle of claim 17, wherein each of the instrument panel support assembly, the steering mechanism, the pedal assembly and the suspension system are directly attached to the unitary cast component.

19. The small utility vehicle of claim 16, wherein the frame further includes a pair of auxiliary frame rails attached to the unitary cast component and extending rearwardly therefrom and a rear suspension system is coupled to the auxiliary frame rails.

20. The small utility vehicle of claim 16, wherein the small utility vehicle is a golf car.

21. A method of manufacturing a small utility vehicle, the method comprising:
(a) providing a frame including a unitary cast component, the unitary cast component forming a majority of the frame; and
(b) attaching a plurality of vehicle components to the unitary cast component.

22. The method of claim 21, further comprising machining portions of the unitary cast component.

23. The method of claim 22, wherein machining includes threading apertures in the unitary cast component.

24. The method of claim 22, wherein machining includes forming apertures through the unitary cast component.

25. The method of claim 21, further comprising casting the unitary cast component.

26. The method of claim 25, wherein the unitary cast component is aluminum.
